(19) United States
(12) Patent Application Publication
(10) Pub. No.: US 2012/0175122 A1
(43) Pub. Date: Jul. 12, 2012

(54) ELECTRONICS MODULE

(76) Inventors: Steven SIMPSON, Bristol (GB); Stuart Holley, Bedminster (GB)

(21) Appl. No.: 13/009,971

(22) Filed: Jan. 20, 2011

(30) Foreign Application Priority Data
Jan. 10, 2011 (GB) 1001543.6

(51) Int. Cl. E21B 41/04; H04B 13/02

(52) U.S. Cl. 166/335; 340/850

(57) ABSTRACT

An electronics module for an underwater well installation, comprising a housing and first and second electronics components, the said first and second electronics components relating to diverse systems and being located within the housing.

### BACKGROUND OF THE INVENTION

1. Field of the Invention

This invention relates to an electronics module for an underwater well installation, an underwater well installation comprising such a module, and a method of housing electronics components of diverse systems at an underwater well installation. In particular, the invention is suitable for a subsea hydrocarbon extraction well installation.

2. Description of Related Art

Control and monitoring of a subsea well is generally achieved through communication between a surface platform and the well, typically via an umbilical. This terminates at the subsea end at an umbilical termination assembly (UTA), which may house a variety of electronics modules, for example, a router module such as a communication electronic module (CEM) mounted within a power and communications distribution module (PCDM), or a subsea electronics module (SEM). Different modules may be associated with different aspects of the well system, for example process monitoring (data acquisition), or safety and automation (process control) systems. Each of these systems may be integrated within separate and independent networks, which may make use of individual communications systems. For the aspects mentioned above for example, signals associated with process monitoring may be sent to the surface via optical lines within the umbilical cable, while safety and automation signals may be transmitted via a communications on power protocol, i.e. superimposed on the power signals transmitted on a copper conductor within the same umbilical.

A typical arrangement of an existing well communications system for a multiple well complex is shown in FIG. 1. A topside control center 1, located for example onshore or at a vessel or rig, communicates via an umbilical cable 2 with a seabed well-field central distribution unit 3. This communication may be for example by optical fiber, or across copper connections, e.g. using a communications on power (COPS) or communications and power (CAPS) system as is known in the art. A further alternative is to use optical fiber for primary communications, with a back-up COPS link. The unit 3 functions as an umbilical termination assembly (UTA) and houses a power and communications distribution module (PCDM) 4 and a subsea electronics module (SEM) 5 housed within a subsea control module (SCM) 6. The SEM 5 is not specific to a well tree, and handles electronic control functions for the multiple well complex. The SCM 6 meanwhile handles hydraulic functions of the well complex, using directional control valves housed within it, which may be opened and closed using electrical signals provided by the SEM 5. Both the terms subsea electronics module, subsea control module and their general functionality are well known in the art. The PCDM 4 houses a router module such as communications electronic module (CEM) 7, which distributes communications to a multiplicity of additional SEMs 8, which are located at each tree mounted at the head of each well, via copper connections. The CEM 7 and SEM 5 are both housed in containers (not shown) and interfaced with electrical and/or optical fiber connectors capable of withstanding the pressure of the subsea environment, such that rugged encapsulation of each container and protection for the connections is required. Any other electronics modules or packs present would also require such encapsulation and protection. These measures involve substantial costs, and furthermore increase the bulk of the electronics modules.

### BRIEF DESCRIPTION OF THE INVENTION

It is an aim of the present invention to overcome these problems. This aim is achieved by providing an electronics module, which includes at least two diverse electronics components within a common housing.

The term “diverse” as used herein in relation to electronics components and systems is taken to mean that the respective electronics components and systems are separate and independent in function and control, such that the operation of one component does not depend or directly impact upon the operation of the other component.

In a preferred embodiment, available space within a modern SEM may be utilized to house the electronics relating to a diverse system, such as the electronics components of a router module such as communications electronic module (CEM) for example. In this way the costs resulting from the need for a separate housing for the CEM are saved. Furthermore there are options to share power supplies as well, resulting in further savings.

In accordance with a first aspect of the present invention there is provided an electronics module for an underwater well installation, comprising a housing and first and second electronics components, the said first and second electronics components relating to diverse systems and being located within the housing.

In accordance with a second aspect of the present invention there is provided a method of housing electronics components of diverse systems at an underwater well installation, comprising the steps of: providing an electronics module including first electronics components located within a housing; and locating a second electronics component within the electronics module, the first and second electronics components relating to diverse systems.

In accordance with a third aspect of the invention, there is provided an underwater well installation comprising a module in accordance with the first aspect.

### BRIEF DESCRIPTION OF THE DRAWINGS

The invention will now be described with reference to the accompanying drawings, in which:

FIG. 1 schematically shows a known well communications system;

FIG. 2 schematically shows a known well system architecture which may be adapted in accordance with the present invention;

FIG. 3 schematically shows a known well tree SEM which may be adapted in accordance with the present invention;

FIGS. 4a and 4b schematically show an electronics module in accordance with the present invention;

FIG. 5 schematically shows a well communications system in accordance with the present invention; and

FIG. 6 schematically shows another well communications system in accordance with the present invention.

### DETAILED DESCRIPTION OF THE INVENTION

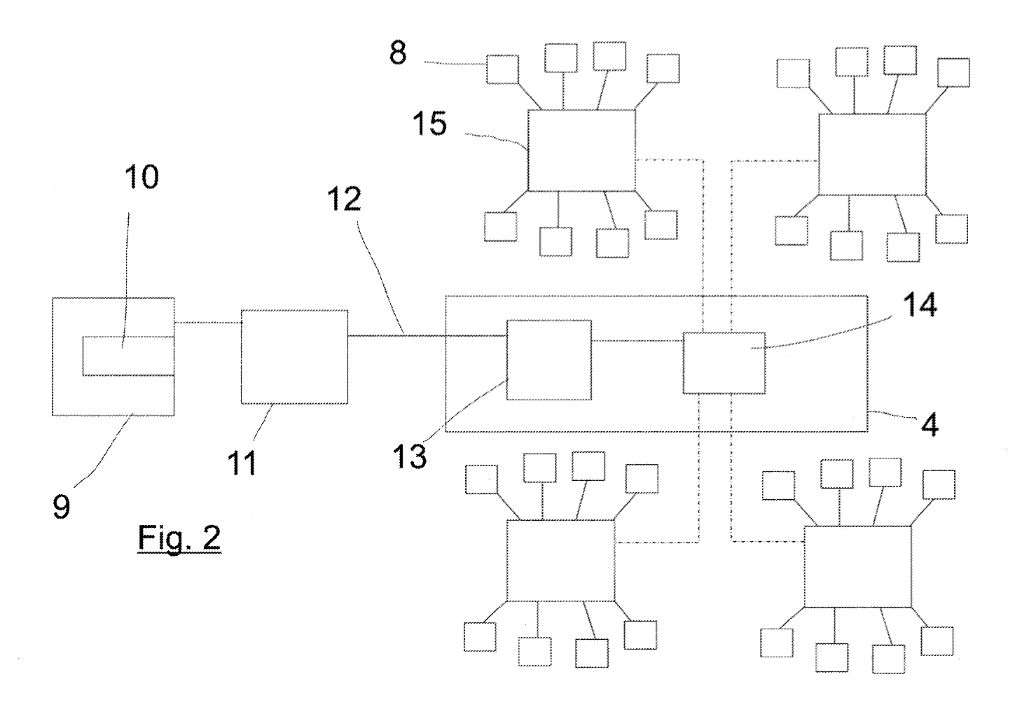

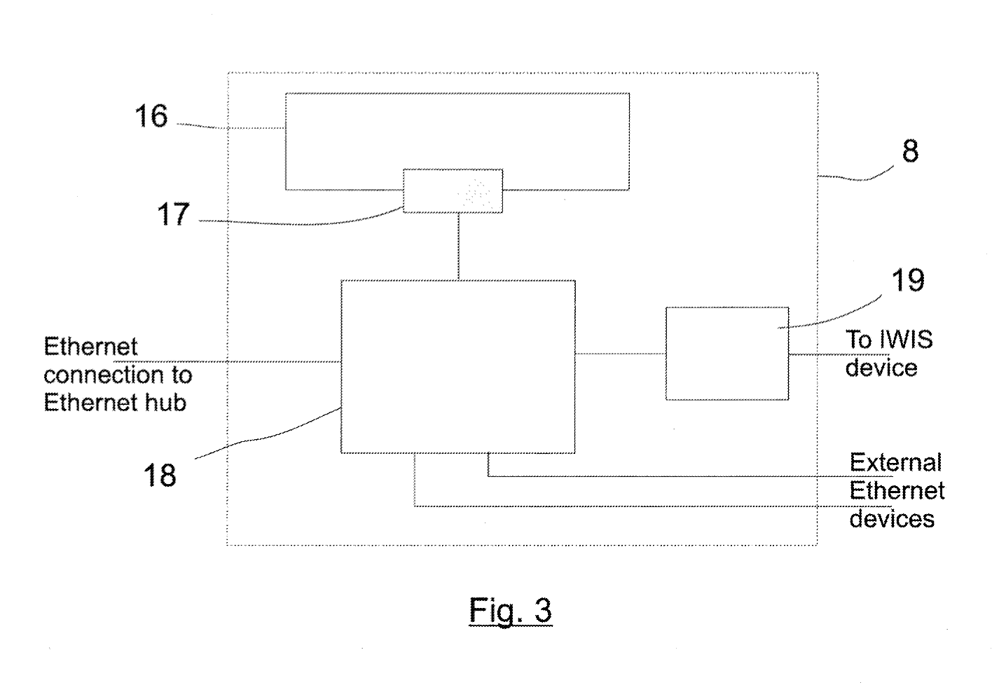

The example described with reference to FIGS. 2 and 3 shows how the invention may be implemented in a known system architecture, such as that disclosed in GB-A-2443237.

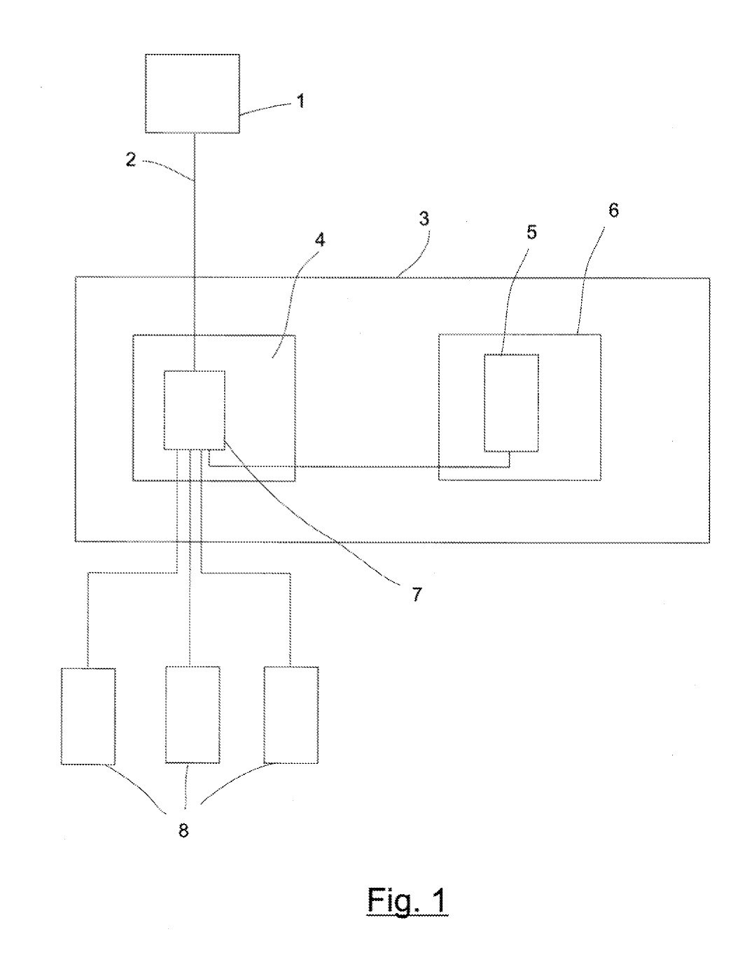

FIG. 2 shows well system architecture known as a “star” system, which provides a communication link between a shore-based master control station (MCS) 9 and a number of SEMs 8 located at each well tree, via subsea templates. The MCS 9 contains Ethernet circuitry 10 to drive an optical Ethernet media convertor (OEMC) 11. This delivers optically modulated digitized data packages to a fiber optic cable 12. Typically this cable 12 is located within an umbilical such as that shown at 2 in FIG. 1, which may be about 600 km long, with the fiber optic cable operating at around 10 mbps. At the other end of the fiber optic cable 12 is a second OEMC 13, which outputs electrical digitized data packages to a primary Ethernet hub 14. Both the OEMC 13 and Ethernet hub 14 are typically housed in a PCDM 4 as also shown in FIG. 1. The primary Ethernet hub 14 outputs to an appropriate required number of secondary Ethernet hubs 15, i.e. templates, in a star configuration. Four of these hubs 15 are shown in FIG. 2 by way of example. Each secondary Ethernet hub 15 feeds a SEM 8 on each well tree.

FIG. 3 schematically shows a LAN configuration set-up of a typical SEM 8. SEM data acquisition and control electronics 16 are provided which interface with an Ethernet enabler 17. An Ethernet hub 18 is provided to link the electronics 16 via enabler 17 both to the template secondary Ethernet hubs 15 (shown in FIG. 2) and an Ethernet to Point to Point Protocol (PPP) converter 19, for example an RS-422 or RS-485 serial interface, to communicate with any devices that utilize an intelligent well interface standard (IWIS). The OEMC 13, primary Ethernet hub 14, and secondary Ethernet hubs 15 would normally have to be housed in a separate router module such as a communications electronic module (CEM), at considerable expense.

In accordance with an embodiment of the present invention however, these components of the communications electronics are instead located within a spare bay of the SEM 5 located in the well field central distribution unit 3. The SEM 5 continues to provide its standard, native, functionality for the production control system.

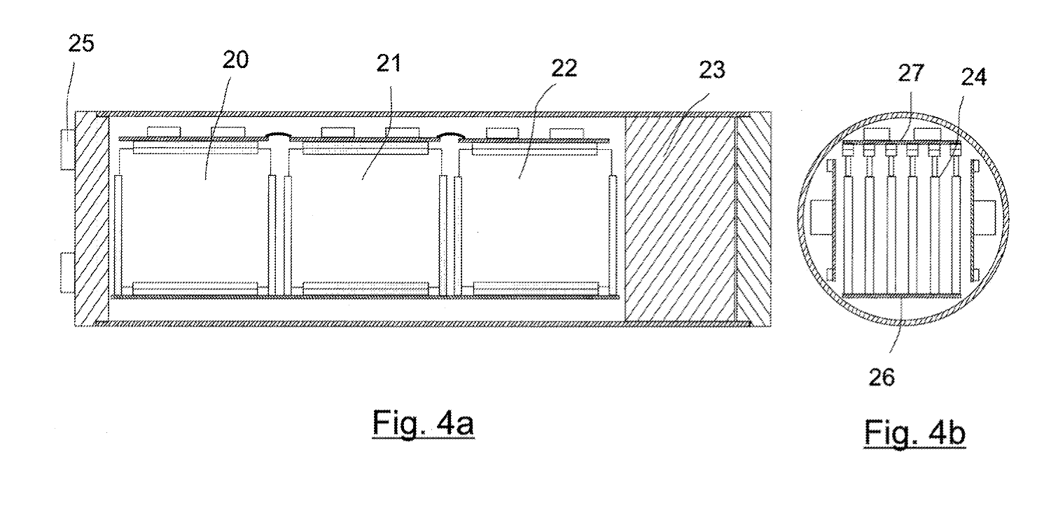

FIGS. 4a and 4b illustrate a modern multiple bay SEM, suitable for use with the present invention. The SEM shown has three bays 20, 21 and 22 for holding electronics components. An integral power supply 23 is provided at one end of the SEM. As shown in the sectional view of FIG. 4b, each bay can house a multiplicity of electronics cards 24, which can interface with each other and/or to external connectors 25 via a motherboard 26, or through LAN configuration components 27, similar to those shown in FIG. 3, mounted on top of the cards 24.

Typically, only one or two card bays are required to control a well and thus the third bay 22 for example can locate the communications electronics components normally housed within a CEM. Furthermore, the integral power supply of the SEM may power the communication components. Connections to the external connectors 25, to connect the LAN to the SEMs of other wells, can be effected through the motherboard 26. The module may be encapsulated in a similar manner as for standard SEMs.

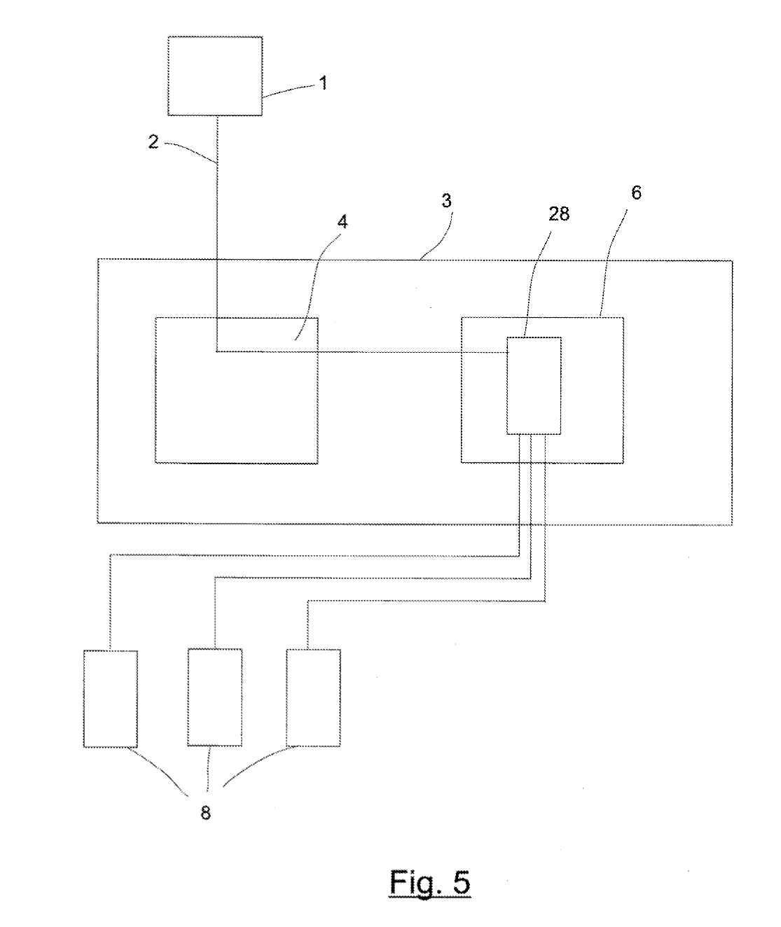

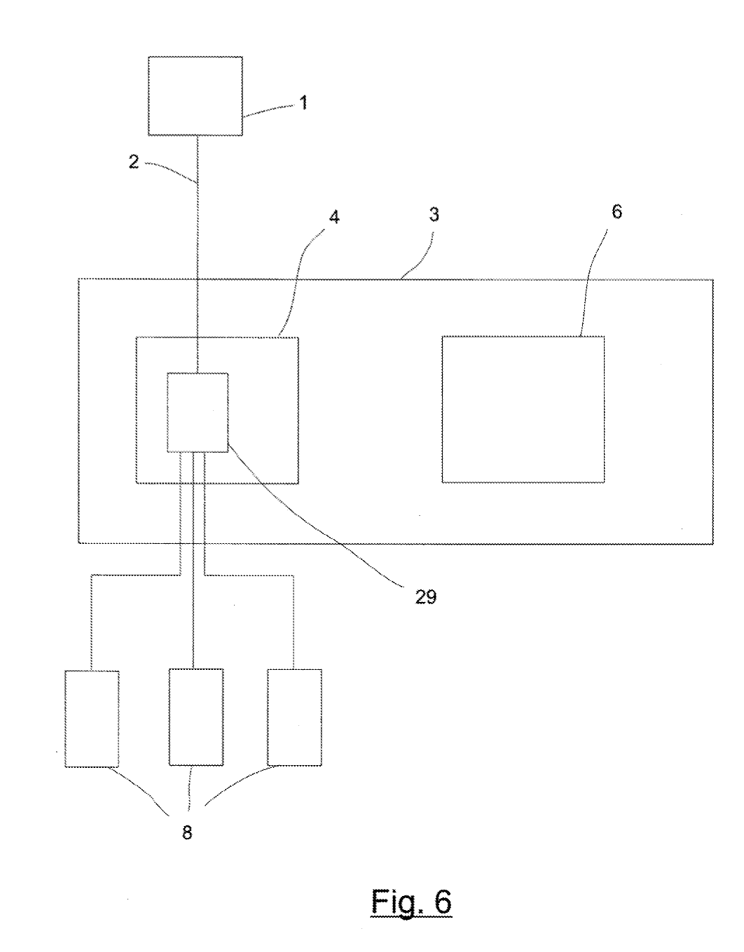

FIGS. 5 and 6 show two possible arrangements for locating the combined module. In FIG. 5, the module 28 is housed within SCM 6, for example at the same location as for the SEM 5 in FIG. 1. This type of arrangement is most practical for utilizations where the SEM components are used to control SCM functions.

FIG. 6 shows an alternative arrangement, in which the combined module 29 is housed within the PCDM 4, for example at the same location as for the CEM 7 in FIG. 1. This type of arrangement may be practical for utilizations where hydraulic functions of an SCM are not required, for example with “all-electric” systems.

In fact, the location of the module is flexible, and it may be located wherever convenient within the well installation.

The present invention enables components of two diverse systems to be housed within a common module. In the first embodiment described above, these are the production control system controlled by the native SEM components and a communications system controlled by the native CEM components. However, the invention is not limited to this, and other embodiments are possible.

In accordance with an alternative embodiment of the present invention, a common module may be used to house the components relating to two diverse SEMs. In other words, the invention enables a dual SEM architecture with two completely segregated power, communications, and related electronics systems, yet with the related components housed within the same module.

In accordance with a further embodiment of the present invention, a common module may be used to house the components relating to both a process control system such as a safety and automation system, and a process monitoring or optimization system such as a data acquisition system, such systems being diverse. In this example, the process control system components may be adapted for connection to a copper communications network, while the process monitoring components may be adapted for connection to an optical communications network.

The above-described embodiments are exemplary only, and other possibilities and alternatives within the scope of the invention will be apparent to those skilled in the art. For example, while the above-described embodiments relate to the inclusion of electronics components relating to two diverse systems within a common module, it is possible to house electronics components relating to more than two diverse systems.

The above described embodiments utilize a standard SEM as the common module, however it is envisaged to use any suitable electronics module, including specifically designed electronics modules.

What is claimed

1. A subsea electronics module for an underwater well installation, the module comprising a housing and first electronic components located within the housing as a first system to provide functions of a subsea electronics module, wherein second electronic components are located in the housing as a second system diverse from the first system.

2. A module according to claim 1, wherein the said first and second systems are formed as electronics boards, located within bays in the housing.

3. A module according to claim 2, wherein said second system is located in a spare bay in the housing.

4. A module according to claim 1, wherein further electronic components are located in the housing as a further system diverse from the first and second systems.

5. A module according to claim 1, wherein said second system provides functions of a subsea electronics module.

6. A module according to claim 1, wherein said second system comprises a communications router module.

7. A module according to claim 1, wherein one of said first and second systems comprises a process control system adapted for connection to a copper communications network and the other of said first and second systems comprises a process monitoring system adapted for connection to an optical communications network.

8. A module according to claim 1, wherein said systems are encapsulated in the housing.

9. An underwater well installation comprising a module in accordance with claim 1.

10. A well installation according to claim 9, comprising a distribution unit located at an underwater location, the distribution unit being adapted for receiving an umbilical cable, wherein the module is housed within the distribution unit.

11. A well installation according to claim 10, wherein the distribution unit houses a subsea control module and the subsea electronics module is housed within the subsea control module.

12. A well installation according to claim 10, wherein the distribution unit houses a power and communications distribution module and the subsea electronics module is housed within the power and communications distribution module.

13. A method of providing a subsea electronics module for an underwater well installation, comprising the steps of:
locating a module including first electronic components within a housing as a first system to provide functions of a subsea electronics module; and
locating second electronic components in the housing as a second system diverse from the first system.

14. A method according to claim 13, wherein the said first and second systems are formed as electronics boards, located within bays in the housing.

15. A method according to claim 14, wherein said second system is located in a spare bay in the housing.

16. A method according to claim 13, wherein further electronic components are in the housing as a further system diverse from the first and second systems.

17. A method according to claim 13, wherein said second system provides functions of a subsea electronics module.

18. A method according to claim 13, wherein said second system comprises a communications router module.

19. A method according to claim 13, wherein one of said first and second systems comprises a process control system adapted for connection to a copper communications network and the other said first and second systems comprises a process monitoring system adapted for connection to an optical communications network.

20. A method according to claim 13, further comprising the step of encapsulating said systems in the housing.
